(19) United States
(12) Patent Application Publication
(10) Pub. No.: US 2026/0024147 A1
(43) Pub. Date: Jan. 22, 2026

(54) SYSTEM AND METHOD FOR IDENTIFYING TECHNICAL UNCERTAINTIES FOR DETERMINING TAX CREDIT QUALIFICATION

(71) Applicants: John Wiltshire-Gordon, Belmont, MA (US); Joshua Zagorsky, Seattle, WA (US)

(72) Inventors: John Wiltshire-Gordon, Belmont, MA (US); Joshua Zagorsky, Seattle, WA (US)

(21) Appl. No.: 19/272,075

(22) Filed: Jul. 17, 2025

Related U.S. Application Data
(60) Provisional application No. 63/673,792, filed on Jul. 22, 2024.

(51) Int. Cl. G06Q 40/10; G06F 8/71; G06F 40/30

(52) U.S. Cl. CPC G06Q 40/10; G06F 8/71; G06F 40/30

(57) ABSTRACT

Various embodiments are disclosed for identifying technical uncertainties for determining tax credit qualification, including electronically accessing project data comprising a plurality of task data objects, partitioning the plurality of task data objects into a plurality of objective groups, and identifying technical uncertainties associated with the task data objects of each objective group.

### CROSS-REFERENCE TO RELATED APPLICATIONS

I hereby claim the benefit under 35 U.S.C. Section 119(e) of U.S. Provisional application 63/673,792 filed on Jul. 22, 2024.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to preparation of research and development credit studies and more particularly pertains to a new system or method for analyzing documentation to identify technical uncertainties and alternatives evaluated in attempting to remove the uncertainties.

### (2) Description of Related Art Including Information Disclosed Under 37 CFR 1.97 and 1.98

A tax credit for increasing research activities is defined under Internal Revenue Code Section 41. To qualify for this tax credit, documentation must be provided showing that expenses for research activities must have been undertaken to resolve a technical uncertainty, and that one or more alternatives were evaluated in a process of experimentation. Identification of such technical uncertainties and assessment of evaluated alternatives is time-consuming and typically relies significantly on the memories of subject matter experts who manage or are otherwise involved in research and development programs. Current devices available to aid such credit studies are basically survey tools that do little or nothing to aid the memory of relevant subject matter experts. A different tool is needed which will analyze different work tasks as documented in task management systems and implemented and documented in codebase version control systems to facilitate the identification of technical uncertainties and the assessment of evaluated alternatives to resolve such uncertainties.

### BRIEF SUMMARY OF THE INVENTION

An embodiment of the disclosure meets the needs presented above by generally comprising a system for identifying tax credit parameters relevant to research and development tax credits. The system comprises one or more processors, a memory, and computer-executable instructions stored in the memory. The computer-executable instructions, when retrieved from the memory and executed by the one or more processors, cause the one or more processors to electronically access project data comprising a plurality of task data objects, partition the plurality of task data objects into a plurality of objective groups, and identify technical uncertainties associated with the task data objects of each objective group. The task data objects of each are associated with a common objective.

In another embodiment, a computer-implemented method of identifying tax credit parameters relevant to research and development tax credits is provided. The computer-implemented method comprises, as implemented by one or more computing devices configured with specific executable instructions, electronically accessing project data comprising a plurality of task data objects, partitioning the plurality of task data objects into a plurality of objective groups, and identifying technical uncertainties associated with the task data objects of each objective group. The task data objects of each are associated with a common objective.

In another embodiment, a non-transitory computer storage medium stores computer-executable instructions that, when executed by one or more processors, cause the one or more processors to electronically access project data comprising a plurality of task data objects, partition the plurality of task data objects into a plurality of objective groups, and identify technical uncertainties associated with the task data objects of each objective group. The task data objects of each are associated with a common objective.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a block diagram illustrating a tax credit parameter identification system in communication with a version control system and a task management system according to an embodiment of the disclosure.

FIG. 2 is a flow diagram of a routine for identifying technical uncertainties and evaluated alternatives for resolving those technical uncertainties according to an embodiment of the disclosure.

FIG. 3 is a block diagram of a computing system configured to implement features of some embodiments.

### DETAILED DESCRIPTION OF THE INVENTION

Embodiments of the disclosure will now be described with reference to the accompanying figures.

Tax credits are available to businesses which take part in certain research and development activities. Businesses must provide documentation that they qualify for such tax credits, which may include providing documentation of qualification for such tax credits. This disclosure describes embodiments of systems and methods which may be used to identify certain parameters necessary for qualification for these tax credits. Specifically, the embodiments identify parameters of technical uncertainties and alternatives to resolving such technical uncertainties. A “technical uncertainty” for the purposes of this disclosure may exist when information available to a user does not establish the capability or method for developing or improving a business component. “Business component” may refer to any product, process, computer software, technique, formula, or invention that is intended to be held for sale, lease, or license, or to be used by the user in trade or business. “Alternatives” for resolving technical uncertainties (referred to herein as “alternative resolutions”) refers to different solutions or potential solutions that are evaluated in a systematic process of experimentation to resolve technical uncertainties.

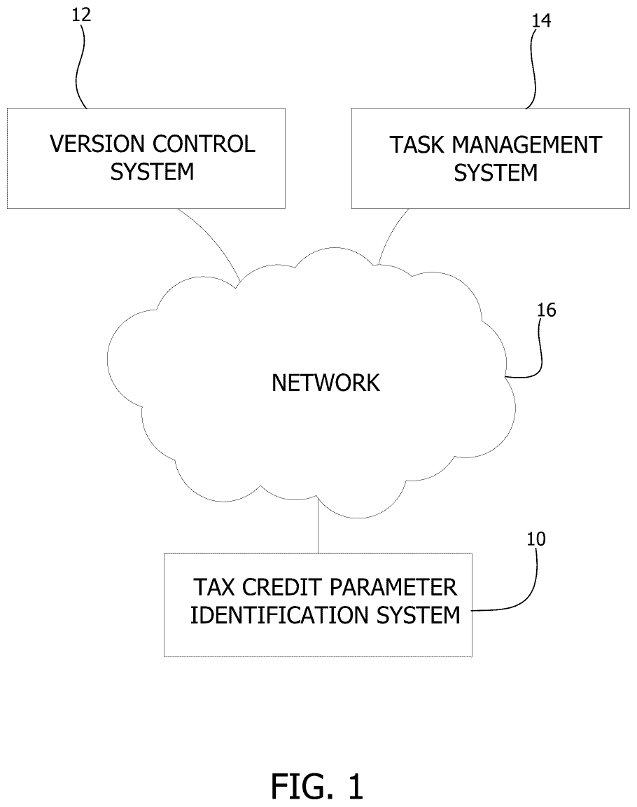

FIG. 1 illustrates an example embodiment of a tax credit parameter identification system 10 for identifying technical uncertainties and alternative resolutions, and communicating results in a generated report. The tax credit parameter identification system 10 is in communication over a network 16 with a version control system 12 and a task management system 14. The version control system 12 may be a system for controlling, organizing, and tracking different versions of source code. The task management system 14 may be any system for organizing and tracking tasks for a project or other activity. The network 16 may be a local area network (LAN), a wide area network (WAN), and/or the Internet. The network 16 may communicate via wired, wireless, or a combination of wired and wireless communication links. The network 16 may be one of multiple networks over which the tax credit parameter identification system 10 communicates with the version control system 12 and the task management system 14. Data may be imported from the version control system 12 and the task management system 14 via one or more application programming interfaces (APIs) or via a script or process that downloads data into a comma-separated values (CSV) file or other suitable file. The tax credit parameter identification system 10 may obtain data from multiple version control systems and task management systems or from other sources.

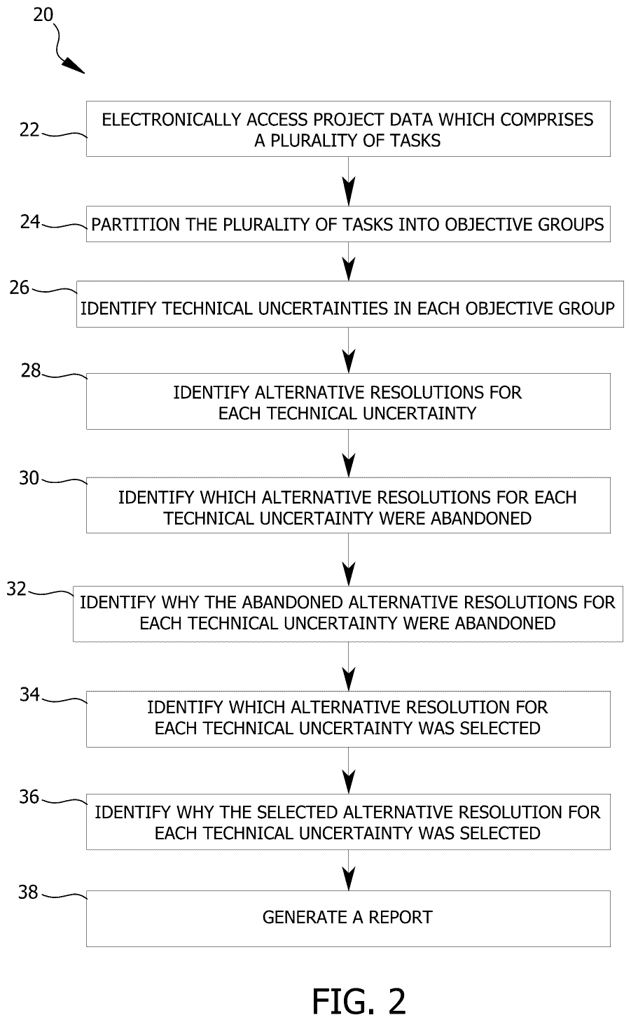

FIG. 2 depicts a flow diagram of an example routine 20 that the tax credit parameter identification system 10 may execute to identify technical uncertainties and alternative resolutions. Computer-executable instructions may be loaded to or otherwise accessed in computer readable memory and executed by one or more processors in order to implement the routine 20. At block 22, project data comprising a plurality of task data objects is electronically accessed. The project data may be electronically accessed from the version control system 12 and the task management system 14, for example. Each task data object is associated with a task to be performed for a project, which may include, for example, a codebase change suggestion (i.e., pull requests or merge requests) or a task management issue (which refers to a task, issue, step, or the like in a project). The task data objects which are associated with task management issues may have a hierarchical relationship with other data objects. For example, multiple task management issues may be categorized under a parent task which is represented in the task management system 14 by another data object.

At block 24, the plurality of task data objects is partitions into a plurality of objective groups in which the task data objects of each objective group are associated with a common objective. Agglomerative hierarchical clustering may be applied to one or more text strings of the task data objects to determine common objectives. For example, the task data objects may include text strings which provide information such as titles, descriptions, authoring engineers, commenting engineers, the date range the task data object was worked on, links or references to other task data objects, or the like, and different vector embeddings may be used to determine common objectives and cluster the task data objects accordingly. Task data objects may also be placed in objective groups in which the task data objects of each group are associated with a common parent task as defined in the task management system 14. Other parameters also may be used to sort the task data objects into the objective groups.

At block 26, technical uncertainties associated with the task data objects of each group are identified. A language model may be applied to the task data objects to detect semantic uncertainty in text strings of the task data objects. For example, the language model may identify phrases in code review comment threads indicating that an engineer believes a codebase change suggestion is unlikely to succeed, which may result in an identification of a technical uncertainty. Keywords or key phrases also may be searched for in the text strings of the task data objects. For example, a comment in a codebase change suggestion including the phrase “could try” may result in an identification of a technical uncertainty. Identifying technical uncertainties also may comprise identifying codebase change suggestions which were closed without being merged into a codebase or were replaced by alternative codebase change suggestions, wherein closed or replaced codebase change suggestions indicates the presence of a technical uncertainty. Instances when the codebase was refactored may also indicate the presence of a technical uncertainty, which may be identified by detecting when a large number of lines of code were added to and removed from the same file or to and from different files. Such instances may indicate a technical uncertainty, especially in the presence of other indicators. Identifying technical uncertainties also may comprise identifying codebase change suggestions which were assigned a draft status at some point (or at all points) during the work on those codebase change suggestions. “Draft status” as used herein refers to a designation which indicates that a codebase change suggestion is incomplete or not yet ready for formal review and merging into a main codebase.

The indicators of a presence of a technical uncertainty described herein may vary in their likelihood of identifying the presence of the technical uncertainty. As such, proportional weight may be given to different indicators, and such weights may vary depending on the interpretation of comments or other text strings of the task data objects via the language model. Objective groups with the highest indicator weights may be selected for inclusion in further analysis and in a resultant report, as these objective groups are most likely to contain technical uncertainties. A threshold indicator weight may be used to indicate which objective groups are to be selected for continued analysis and which objective groups will not be further analyzed by the tax credit parameter identification system. In other embodiments, objective groups may be selected for continued analysis based on other parameters or based on relative proportions of indicator weights in relation to the indicator weights of other objective groups.

Blocks 28 through 38 may use a language model to analyze text strings to complete the analysis described herein. At block 28, alternative resolutions for each technical uncertainty which were evaluated are identified. Multiple attempts at suggesting codebase changes for a particular objective and comments in codebase change suggestions and task management issues may be analyzed to determine which alternative resolutions were evaluated. Alternative resolutions may be evaluated by attempting to implement them or by simulating or modeling the solutions separately from direct implementations into the codebase.

At block 30, alternative resolutions which were abandoned for each technical uncertainty are identified. At block 32, the reason why the abandoned alternative resolutions were abandoned for each technical uncertainty is identified. This may optionally occur as the reasons for abandonment may not be present in the task data objects. At block 34, the alternative resolution which was selected for each technical uncertainty is determined, and at block 36, the reason why the selected alternative resolution was selected is determined if present in the task data objects.

At block 38, a report is generated which comprises the technical uncertainties, the alternative resolutions for each technical uncertainty, which alternative resolutions were abandoned for each uncertainty, why the abandoned alternative resolutions were abandoned, which alternative resolution was selected, and why the selected resolution was selected. The report may be written in paragraph form using a language model. In other embodiments or other uses, an alternative report may be generated after identifying the objective groups with the greatest likelihood of a presence of a technical uncertainty, and the alternative report may contain text strings in which uncertainty was detected by the language model. The alternative report may be written only as a list or a table such that a viewer of the report may compare the text strings to a memory of the viewer in preparation of writing a final report. Varying levels of information may be communicated at various times via the tax credit parameter identification system 10 and may be done through various reports or readouts. Any of the reports, readouts, or other results may be displayed on a display screen module, printed on paper, or otherwise communicated in a perceivable manner.

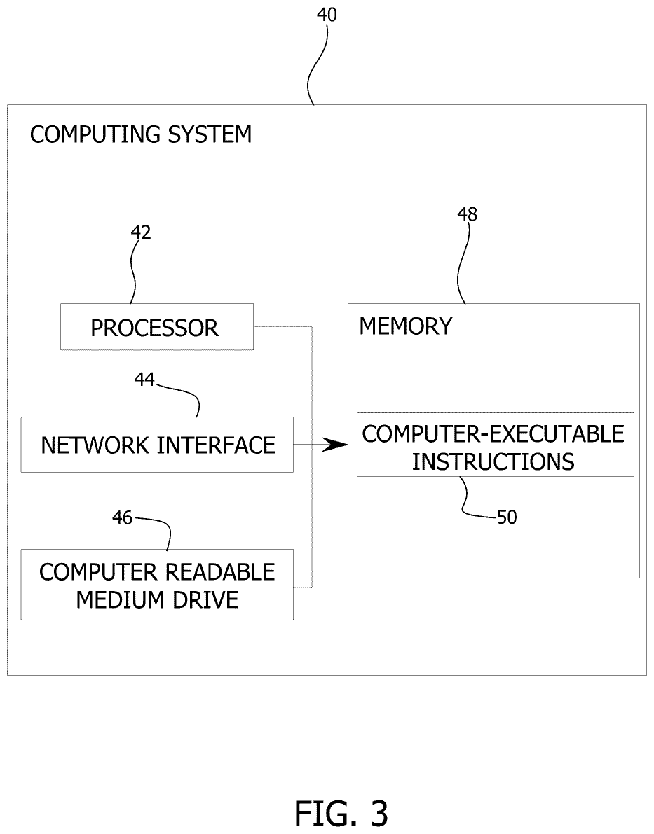

FIG. 3 illustrates a computing system 40 which is configured to implement various functions described herein. The computing system 40 may be a physical host computing device on which the tax credit parameter identification system 10 or some portion thereof is implemented. The computing system 40 includes a processor 42, a network interface 44, a computer readable medium drive 46, and a computer readable memory 48. The computer readable medium drive 46 may comprise a high density disk (HDD), a solid state drive (SSD), a flash drive, or another persistent non-transitory computer readable medium. The computer readable memory 48 may comprise a random access memory or another volatile non-transitory computer readable medium. The computer readable memory 48 includes computer-readable executable instructions 50 that the processor 42 may execute in order to implement one or more embodiments.

Generally, a computing device in accordance with at least one possible embodiment of the present invention will also include one or more data storage devices, or be operatively connected to such storage devices, or both. However, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media, such as, for example, light pulses passing through a fiber-optic cable, or electrical signals transmitted through a wire.

In some embodiments, the steps and actions of the application instructions described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integrated into a processor. Further, in some embodiments, the processor and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product. Those skilled in the art would understand that each block of any flowchart illustrations and/or block diagrams in the figures, and combinations of blocks in any flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in any flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function or functions. In some embodiments, the functions noted in the blocks can occur out of the order noted in the Figures. For example, two or more blocks shown in succession could be executed concurrently, substantially or essentially concurrently, or in reverse order, depending upon the functionality involved. In some embodiments, each block of the block diagrams and/or flowchart illustrations, and combinations of blocks in the block diagrams and/or flowchart illustrations, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include, for example, routines, programs, components, and data structures that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices, such as personal data assistants, tablet or notebook computers, and mobile phones or smartphones, microprocessor-based or programmable consumer or industrial electronics, and other computer systems and devices. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets, such as, for example, data from one component interacting with another component in a local system, distributed system, and/or across a network such as the Internet with other systems via the signal. As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, such as, for example, within a cloud computing system.

Processors suitable for the execution of computer readable program instructions include both general and special purpose microprocessors and any one or more processors of any digital computing device. For example, each processor may be a single processing unit or a number of processing units and may include single or multiple computing units or multiple processing cores. The processor or processors can be implemented as one or more microprocessors, microcomputers, microcontrollers, digital signal processors, central processing units, state machines, logic circuitries, and/or any devices that manipulate signals based on operational instructions. For example, the processor or processors may be one or more hardware processors and/or logic circuits of any suitable type specifically programmed or configured to execute the algorithms and processes described herein. The processor or processors can be configured to retrieve and execute computer readable program instructions stored in the computer-readable media, which can program the processor or processors to perform the functions described herein.

In this disclosure, the term “processor” or “microprocessor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the system can also be implemented in cloud computing environments. In this context, “cloud computing” refers to a model for enabling ubiquitous, convenient, on-demand network access to a shared pool of configurable computing resources, such as, for example, networks, servers, storage, applications, and services, that can be rapidly provisioned via virtualization and released with minimal management effort or service provider interaction and then scaled accordingly. A cloud model can be composed of various characteristics, such as, for example, on-demand self-service, broad network access, resource pooling, rapid elasticity, and measured service, service models, such as, for example, Software as a Service (“SaaS”) and Platform as a Service (“PaaS”), Infrastructure as a Service (“IaaS”), and deployment models such as, for example, private cloud, community cloud, public cloud, and hybrid cloud.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A system for identifying tax credit parameters relevant to research and development tax credits, the system comprising:
one or more processors;
a memory; and
computer-executable instructions stored in the memory, wherein the computer-executable instructions, when retrieved from the memory and executed by the one or more processors, cause the one or more processors to:
electronically access project data comprising a plurality of task data objects;
partition the plurality of task data objects into a plurality of objective groups, wherein the task data objects of each objective group are associated with a common objective; and
identify technical uncertainties associated with the task data objects of each objective group.

2. The system of claim 1, wherein a subset of the plurality of task data objects represents a plurality of codebase change suggestions.

3. The system of claim 2, wherein a subset of the plurality of task data objects represents a plurality of task management issues.

4. The system of claim 1, wherein partitioning the plurality of task data objects includes agglomerative hierarchical clustering applied to one or more text strings of the plurality of task data objects.

5. The system of claim 1, wherein partitioning the plurality of task data objects includes grouping task data objects into respective objective groups which are associated with parent tasks as defined in a task management system.

6. The system of claim 1, wherein identifying technical uncertainties associated with the task data objects of each objective group includes applying a language model to detect semantic uncertainty in text strings of the plurality of task data objects.

7. The system of claim 1, wherein identifying technical uncertainties associated with the task data objects of each objective group includes searching for keywords or key phrases in text strings of the plurality of task data objects which are indicative of technical uncertainty.

8. The system of claim 1, wherein identifying technical uncertainties associated with the task data objects of each objective group includes identifying codebase change suggestions which were closed without being merged into a codebase or were replaced by alternative codebase change suggestions.

9. The system of claim 1, wherein identifying technical uncertainties associated with the task data objects of each objective group includes identifying instances in which the codebase was refactored.

10. The system of claim 1, wherein identifying technical uncertainties associated with the task data objects of each objective group includes identifying codebase change suggestions that were assigned a draft status.

11. The system of claim 1, wherein the computer-executable instructions further causes the one or more processors to identify alternative resolutions for each technical uncertainty which were evaluated by applying a language model.

12. The system of claim 11, wherein the computer-executable instructions further causes the one or more processors to identify which alternative resolutions were abandoned for each technical uncertainty by applying a language model.

13. The system of claim 11, wherein the computer-executable instructions further causes the one or more processors to identify which alternative resolution was selected for each technical uncertainty by applying a language model.

14. The system of claim 13, wherein the computer-executable instructions further causes the one or more processors to identify why the selected alternative resolution was selected for each technical uncertainty.

15. The system of claim 10, wherein the computer-executable instructions further causes the one or more processors to:
identify which alternative resolutions were abandoned for each technical uncertainty by applying a language model;
identify which alternative resolution was selected for each technical uncertainty by applying a language model;
identify why the selected alternative resolution was selected for each technical uncertainty; and
generate a report comprising the technical uncertainties, the alternative resolutions for each technical uncertainty, which alternative resolutions were abandoned for each uncertainty, why the abandoned alternative resolutions were abandoned, which alternative resolution was selected, and why the selected resolution was selected.

16. A computer-implemented method of identifying tax credit parameters relevant to research and development tax credits, the computer-implemented method comprising, as implemented by one or more computing devices configured with specific executable instructions:
electronically accessing project data comprising a plurality of task data objects;
partitioning the plurality of task data objects into a plurality of objective groups, wherein the task data objects of each objective group are associated with a common objective; and
identifying technical uncertainties associated with the task data objects of each objective group.

17. The computer-implemented method of claim 16, wherein:
the plurality of task data objects includes a first subset of task data objects representing a plurality of codebase change suggestions and a second subset of task data objects representing a plurality of task management issues;
partitioning the plurality of task data objects includes:
agglomerative hierarchical clustering applied to one or more text strings of the plurality of task data objects; and
grouping task data objects into respective objective groups which are associated with parent tasks as defined in a task management system;
identifying technical uncertainties associated with the task data objects of each objective group includes:
applying a language model to detect semantic uncertainty in text strings of the plurality of task data objects;
searching for keywords or key phrases in text strings of the plurality of task data objects which are indicative of technical uncertainty;
identifying codebase change suggestions which were closed without being merged into a codebase or were replaced by alternative codebase change suggestions; and
identifying instances in which the codebase was refactored; and
identifying codebase change suggestions that were assigned a draft status; and
further comprising:
identifying alternative resolutions for each technical uncertainty which were evaluated by applying a language model;
identifying which alternative resolutions were abandoned for each technical uncertainty by applying a language model;
identifying why the abandoned alternative resolutions were abandoned for each technical uncertainty by applying a language model;
identifying which alternative resolution was selected for each technical uncertainty by applying a language model;
identifying why the selected alternative resolution was selected for each technical uncertainty; and
generating a report comprising the technical uncertainties, the alternative resolutions for each technical uncertainty, which alternative resolutions were abandoned for each uncertainty, why the abandoned alternative resolutions were abandoned, which alternative resolution was selected, and why the selected resolution was selected.

18. A non-transitory computer storage medium storing computer-executable instructions that, when executed by one or more processors, cause the one or more processors to:
electronically access project data comprising a plurality of task data objects;
partition the plurality of task data objects into a plurality of objective groups, wherein the task data objects of each objective group are associated with a common objective;
identify technical uncertainties associated with the task data objects of each objective group.

19. The non-transitory computer storage medium of claim 18, wherein:
the plurality of task data objects including a first subset of task data objects representing a plurality of codebase change suggestions and a second subset of task data objects representing a plurality of task management issues;
partitioning the plurality of task data objects includes:
agglomerative hierarchical clustering applied to one or more text strings of the plurality of task data objects; and
grouping task data objects into respective objective groups which are associated with parent tasks as defined in a task management system;
identifying the technical uncertainties associated with the task data objects of each objective group includes:
applying a language model to detect semantic uncertainty in text strings of the plurality of task data objects;
searching for keywords or key phrases in text strings of the plurality of task data objects which are indicative of technical uncertainty;
identifying codebase change suggestions which were closed without being merged into a codebase or were replaced by alternative codebase change suggestions; and
identifying instances in which the codebase was refactored; and
identifying codebase change suggestions that were assigned a draft status; and
the computer-executable instructions, when executed by the one or more processors, further cause the one or more processors to:
identify alternative resolutions for each technical uncertainty which were evaluated by applying a language model;
identify which alternative resolutions were abandoned for each technical uncertainty by applying a language model;
identify why the abandoned alternative resolutions were abandoned for each technical uncertainty by applying a language model;
identify which alternative resolution was selected for each technical uncertainty by applying a language model;
identify why the selected alternative resolution was selected for each technical uncertainty; and
generate a report comprising the technical uncertainties, the alternative resolutions for each technical uncertainty, which alternative resolutions were abandoned for each uncertainty, why the abandoned alternative resolutions were abandoned, which alternative resolution was selected, and why the selected resolution was selected.
